(19) United States
(12) Patent Application Publication
(10) Pub. No.: US 2007/0153137 A1
(43) Pub. Date: Jul. 5, 2007

(54) Display device with automatically rotated image and method thereof

(75) Inventors: Yueh-hann Hsu, Chung-Ho City, Taipei (TW); Ming-nan Wu, Chung-Ho City, Taipei (TW)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: AmTRAN TECHNOLOGY CO., LTD, Chung Ho City (TW)

(21) Appl. No.: 11/549,550

(22) Filed: Oct. 13, 2006

(30) Foreign Application Priority Data
Dec. 27, 2005 (TW) 094146854

(51) Int. Cl. H04N 3/14

(52) U.S. Cl. 348/790

(57) ABSTRACT

A display device with automatically rotated images and a method thereof are provided. When the display device is rotated, the display device automatically switches the displaying direction of the image and maintains a sound output balance. A magnetic sensor is used to sense the change in magnetic flux generated when the display device is rotated, so as to sense the rotation of the display device. A microprocessor control unit (MCU) is used to determine the processing procedures for image and sound according to the change in the magnetic flux, and control the outputting of image and sound together with the processing procedures, so as to adjust the image and sound after the displaying image has been rotated.

This non-provisional application claims priority under 35 U.S.C. §119(a) on Patent Application No(s). 094146854 filed in Taiwan, R.O.C. on Dec. 27, 2005, the entire contents of which are hereby incorporated by reference.

### BACKGROUND OF THE INVENTION

1. Field of Invention

The present invention relates to a display device, and more particularly, to a display device for automatically switching the image and maintaining the sound balance when the display device is rotated.

2. Related Art

With the development of displaying technology, liquid crystal display (LCD) has become a mainstream technique for the screen of the desktop computer and liquid crystal TV, and also occupies an important position at the displaying for the notebook computer and cell phone. The developing of LCD not only focuses on enhancing the response speed and viewing angle and enlarging the size of the display panel, but also involves in TV application and has a multi-channel sound system, which has become a video/audio multimedia appliance with computer mode and television mode. Furthermore, as for the developing of other functions, e.g., freely rotating the screen allows the displaying image to rotate automatically along with the rotation of the display, such that the user dose not have to frequently scroll the webpage when browsing the webpage, designing diagrams or tables, thus providing convenience and enhancing the efficiency of using the space of the screen.

As for the conventional art of automatically rotating the displaying image, e.g., ROC Patent Gazette Publication No. 00440786 entitled “Automatically rotated display device” filed on 16 Jun., 2001, wherein a sensor is used to sense the horizontal displacement and vertical displacement of the display, a horizontal sensing signal and a perpendicular sensing signal are generated respectively by the two displacements, a direction-displaying data is generated by a microprocessor through a predetermined program according to the two sensing signals, and a direction-controlling data is generated by a display controller, so as to control the displaying direction of the image. However, as for the method of controlling the displaying direction of the image by sensing the relative displacement of the display, the problem that the sensing speed restricts the displaying speed occurs, and also, the mechanical jittering causes errors in sensing the displacement.

### SUMMARY OF THE INVENTION

In view of the above problem, the present invention discloses a display device with automatically rotated images and a method thereof, wherein after the display is rotated, the image is automatically rotated without sensing the displacement of the display.

The display device with automatically rotated images provided in the present invention comprises a magnetic sensor, a microprocessor control unit (MCU) and a displaying control unit.

The technical method of using the display device of the present invention comprises the following steps. The magnetic sensor is used to sense the change in magnetic flux when the display device is rotated, and send out a sensing signal to the MCU according to the change in the magnetic flux, so as to tell it about the rotating angle. Next, the MCU generates a displaying direction signal through a predetermined program according to the sensing signal and then transfers the displaying direction signal to the displaying control unit. The displaying control unit generates a displaying control message for controlling the rotating of the displaying image. Furthermore, when the display device is rotated, the image is divided by a software technique, thus different divided images can be used to display different images. On the other aspect, the display device further comprises four loudspeakers spaced by a fixed distance, and as the image rotates, the loudspeakers are switched to maintain the left and right sound channels to be unchanged.

In summary, the device and method disclosed in the present invention adjust the image and sound by sensing the change in the magnetic flux for the display device, and the efficiency of using the screen space is achieved through software technique.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a block diagram of the function of a display device with automatically rotated images according to the present invention.

FIG. 2 is a schematic view of the Hall effect.

FIG. 3 is a predetermined program of the MCU according to the present invention.

FIG. 4 is a block diagram of the function of another preferable display device with an automatically rotated image according to the present invention.

FIG. 5A is an appearance view of the display device before being rotated according to the present invention.

FIG. 5B is an appearance view of the display device after being rotated according to the present invention.

### DETAILED DESCRIPTION OF THE INVENTION

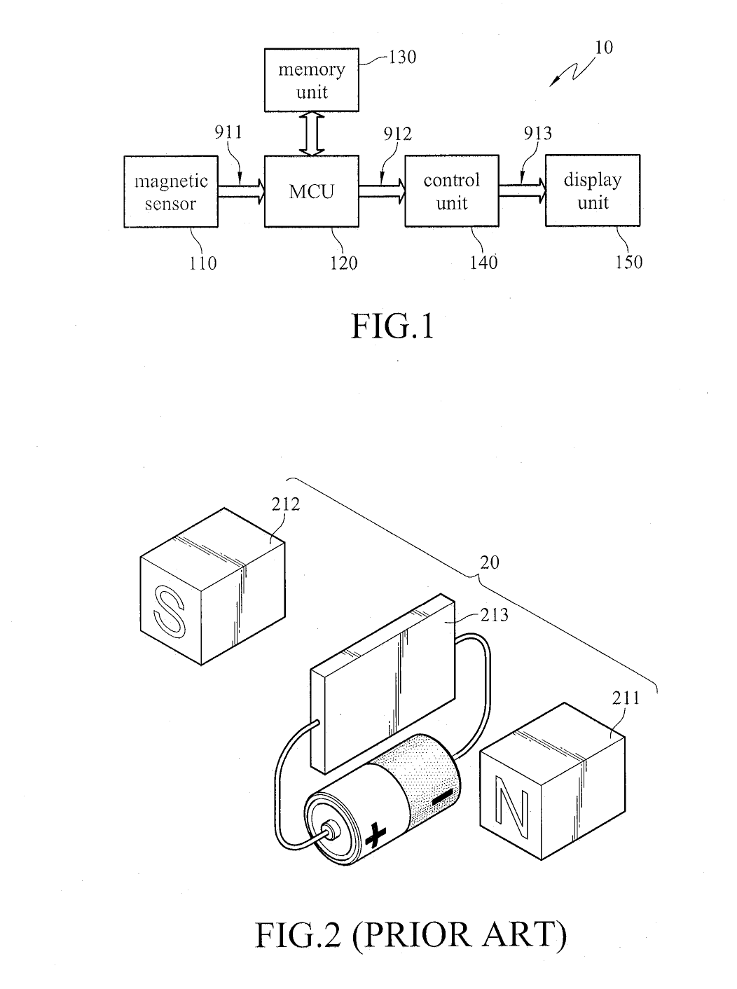

Referring to FIG. 1, it is a block diagram of the function of a display device 10 with an automatically rotated image according to the present invention. The display device 10 has a screen of 16:9, and has a computer input/output mode, a television or another video input/output mode that can be performed at the same time. When the display device 10 is not rotated, the horizontally displayed image for the display device 10 presents a length to width ratio of 16:9 (of course, the present invention is also applicable in a display device with a screen of 16:10). The display device 10 comprises a magnetic sensor 110, a microprocessor control unit (MCU) 120, a memory unit 130, a control unit 140, and a display unit 150. The magnetic sensor 110 is electrically connected to the MCU 120, the MCU 120 is respectively electrically connected to the magnetic sensor 110, the memory unit 130 and the control unit 140, and the control unit 140 is electrically connected to the display unit 150.

The magnetic sensor 110 is a sensor based upon the Hall effect principle. Referring to FIG. 2, it is a schematic view 20 of the Hall effect. By rotating a positive magnetic pole 211 and a negative magnetic pole 212, the magnetic flux in the magnetic field passing through the Hall element 213 is changed, such that the Hall effect is generated. A Hall voltage is produced by sensing the magnetic flux, which is represented by the following Equation (1):
V_{H}=R_{H}IB/d (1).

In Equation (1), V_{H} represents the Hall voltage; R_{H} represents the Hall constant; I represents the current passing through the Hall element 213; B represents the sensed magnetic flux; and d represents the thickness of the Hall element 213.

When the display device 10 is rotated, the positive magnetic pole 211 and the negative magnetic pole 212 are driven to rotate, and the Hall element 213 maintains at the original position, so as to sense the change in the magnetic flux B, and generate a Hall voltage V_{H}.

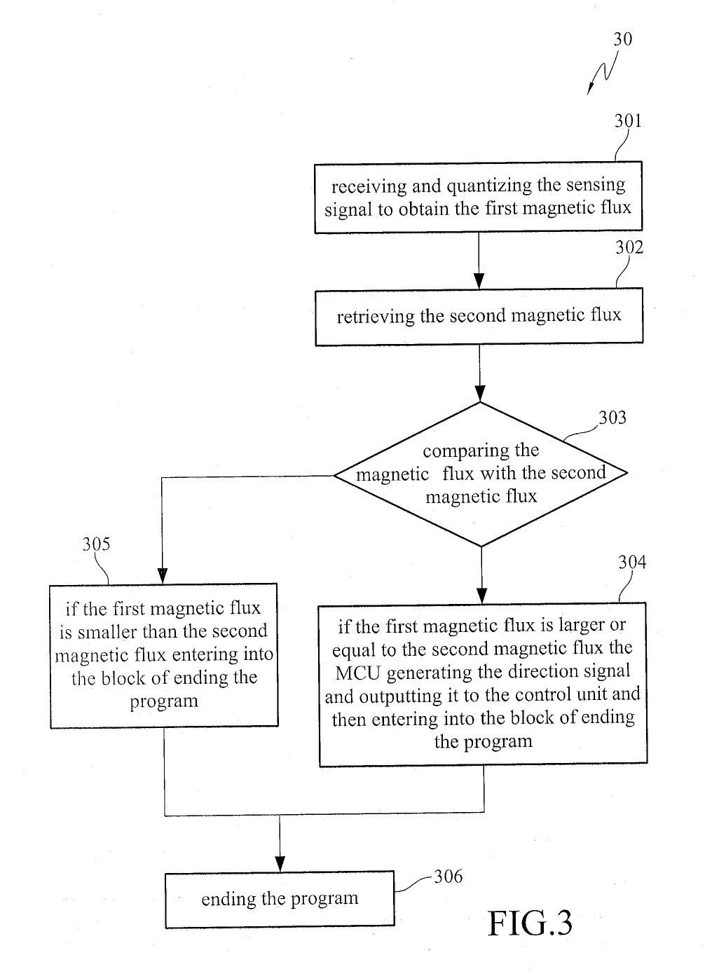

The magnetic sensor 110 provides the Hall voltage V_{H} according to the sensing signal 911, and outputs the sensing signal 911 to the MCU 120. The MCU 120 quantifies the Hall voltage V_{H} represented by the sensing signal 911 into a first magnetic flux T′, i.e., corresponding magnetic flux variation. With respect to the first magnetic flux T′, a second magnetic flux T is stored within the memory unit, which is a standard quantity for the MCU 120 to determine whether to rotate the image or not, or a magnetic flux threshold quantity. The MCU 120 determines whether to rotate the image or not through a predetermined program 30 (referring to FIG. 3) according to the first magnetic flux T′ and the second magnetic flux T. If it is determined to rotate the image, the MCU 120 generates a direction signal 912 and outputs it to the control unit 140, the control unit 140 generates an image control signal 913 according to the direction signal 912 and outputs the image control signal 913 to the display unit 150, and the display unit 150 completes the rotating of the image according to the image control signal 913.

Referring to FIG. 3, it shows the predetermined program 30 of the MCU 120. The predetermined program 30 is executed by the MCU 120, which comprises the following steps: receiving and quantizing the sensing signal 911 to obtain the first magnetic flux T′ (Step 301); retrieving the second magnetic flux T (Step 302); comparing the magnetic flux T′ with the second magnetic flux T (Step 303); if the first magnetic flux T′ is larger or equal to the second magnetic flux T, the MCU 120 generating the direction signal 912 and outputting it to the control unit 140, and then, entering into the block of ending the program (Step 304); if the first magnetic flux T′ is smaller than the second magnetic flux T, entering into the block of ending the program (Step 305); and finally ending the program (Step 306).

Thus, when the first magnetic flux T′ is larger than or equal to the second magnetic flux T, the control unit 140 generates the displaying control signal 913 according to the direction signal 912 output by the MCU 120, so as to make the display unit 150 rotate the image. However, when the first magnetic flux T′ is smaller than the second magnetic flux T, the image is not rotated.

In this embodiment, the proportional allocation of the length and width for the image and the allocation of the displaying district are achieved by software technique after the image has been rotated. That is, when the display device 10 is rotated, the image is not only rotated, but can also be shown with a length and width ratio of 9:16, or maintaining the length and width ratio of 16:9. As for the former circumstance, the area occupied by the image is possibly the whole screen or reduced to a part of the area in the screen, and as for the later circumstance, in order to allow the image to maintain the length and width ratio of 16:9, the area occupied by the image must be reduced to a part of the area in the screen. Combining the above two circumstances, if the image after being rotated is reduced to a part of the area in the screen, the remaining part can be further used for other applications. For example, if the original image is an image in the television input/output mode, and the image after being rotated is reduced to maintaining the length and width ratio of 16:9 and located at the central part or the upper or lower part of the screen, the remaining area can be used for displaying image at a computer or other video input/output mode, that is, a dual mode is performed. Or otherwise, the remaining area can be used to display an electronic program guide (EPG), which is a man machine interface (MMI) for a wireless digital television. After the length and width ratio of the image after being rotated and the allocation and application of the displaying area are determined through the software technique, the software technique may be embedded into the MCU 120, such that the MCU 120 generates the direction signal 912 in accordance with the allocation made through the software technique, and outputs the direction signal 912 to the control unit 140.

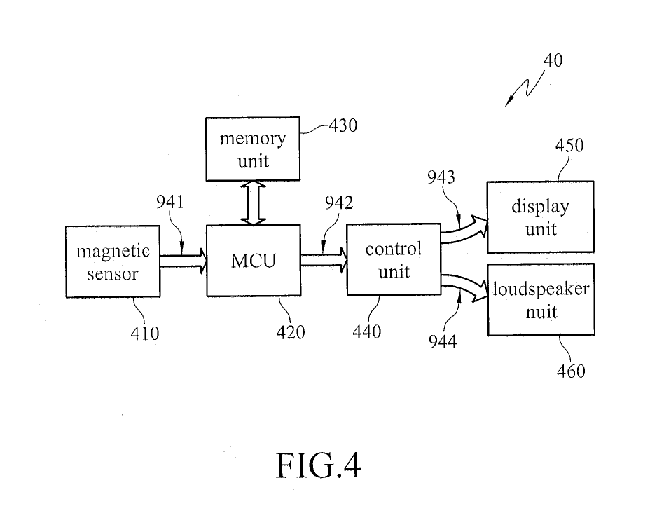

Referring to FIG. 4, it is a block diagram of the function of the display device 40 with an automatically rotated image according to another preferred embodiment of the present invention. The display device 40 has a screen of 16:9, and has both the computer input/output mode and the television or another video input/output mode that can be performed at the same time. When the display device 40 is not rotated, the horizontally displayed image for the display device 40 presents a length and width ratio of 16:9 (Of course, the display device with a screen of 16:10 also may be used). The display device 40 comprises a magnetic sensor 410, an MCU 420, a memory unit 430, a control unit 440, a display unit 450, and a loudspeaker unit 460. The magnetic sensor 410 is electrically connected to the MCU 420, the MCU 420 is respectively electrically connected to the magnetic sensor 410, the memory unit 430 and the control unit 440, and the control unit 440 is respectively electrically connected to the display unit 450 and the loudspeaker unit 460.

When the display device 40 is rotated, the magnetic sensor 410 senses the rotation of the display device 40 and generates a Hall voltage V_{H}, and the sensing signal 941 for representing the Hall voltage V_{H} is output to the MCU 420. The MCU 420 quantizes the Hall voltage V_{H} represented by the sensing signal 941 into a first magnetic flux T′, which is a corresponding magnetic flux variation. With respect to the first magnetic flux T′, a second magnetic flux T is stored within the memory unit, which is a standard quantity for the MCU 420 to determine whether to rotate the image or not, or a magnetic flux threshold quantity. The MCU 420 determines whether to rotate the image or not through a predetermined program 30 according to the first magnetic flux T′ and the second magnetic flux T. If it is determined to rotate the image, the MCU 420 generates a direction signal 942 containing an image direction message and a sound channel direction message, and outputs the direction signal 942 to the control unit 440. The control unit 440 generates an image control signal 943 and a sound channel control signal 944 according to the direction signal 942, and outputs them to the display unit 450 and the loudspeaker unit 460 respectively. The display unit 450 rotates the image according to the image control signal 943, and after the image is rotated, the proportional allocation of the length and width and the allocation of the displaying area are achieved by the MCU 420 together with a software technique. The loudspeaker unit 460 adjusts the output of sound according to the sound channel control signal 944. The proportional allocation of the length and width and the allocation of the displaying area achieved through the predetermined program 30 together with the software technique has already been illustrated in the former embodiment, thus will not be described herein any more.

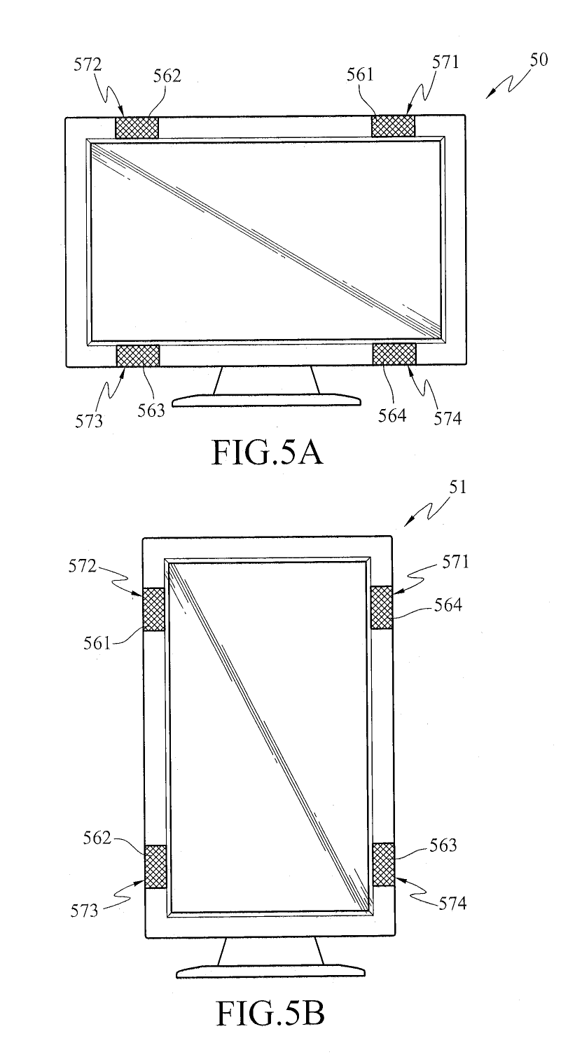

Referring to both FIG. 5A and FIG. 5B, FIG. 5A is an appearance view 50 of the display device 40 before being rotated according to the present invention. FIG. 5B is an appearance view 51 of the display device 40 after being rotated according to the present invention. The loudspeaker unit 460 of the display device 40 comprises a first loudspeaker 561, a second loudspeaker 562, a third loudspeaker 563, and a fourth loudspeaker 564, which are disposed together as a square and spaced with an equal distance between each other, and each of them outputs sounds with each of the sound channels.

As shown in FIG. 5A, when the display device 40 is not rotated, the first sound channel 571 is implemented by the first loudspeaker 561, the second sound channel 572 is implemented by the second loudspeaker 562, the third sound channel 573 is implemented by the third loudspeaker 563, and the fourth sound channel 574 is implemented by the fourth loudspeaker 564. As shown in FIG. 5B, when the display device 40 is rotated in an anti-clockwise direction, the second sound channel 572 is implemented by the first loudspeaker 561, the third sound channel 573 is implemented by the second loudspeaker 562, the fourth sound channel 574 is implemented by the third loudspeaker 563, and the first sound channel 571 is implemented by the fourth loudspeaker 564. When the control unit 440 outputs the sound channel control signal 944 to the loudspeaker unit 460, the above switching process is performed swiftly by a logic gate, thus, the interruption of the sounds cannot be distinguished by human ear. Furthermore, since the loudspeakers are arranged as a square, the sound field achieved after the sounds are converted maintains.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A display device with an automatically rotated image, wherein the display device outputs an image, and when the display device is rotated, the display device automatically rotates the direction of the image, the display device comprising:
a magnetic sensor, for sensing a change in magnetic flux when the display device is rotated, and generating a first message comprising a first magnetic flux according to the change in magnetic flux;
a memory unit, for storing a second message comprising a second magnetic flux;
a microprocessor control unit (MCU), electrically connected to the magnetic sensor, for determining whether to rotate the image or not, and the displaying direction of the image after being rotated according to the first and second messages; and
a control unit, electrically connected to the MCU, for controlling the displaying direction of the image together with the MCU.

2. The display device with an automatically rotated image according to claim 1, wherein the MCU is responsible for proportionally allocating the length and width of the image and adjusting the displaying position of the image.

3. The display device with an automatically rotated image according to claim 1, wherein the display device has a plurality of input/output modes, and the MCU processes the image in each of the input/output modes according each of the input/output modes, and meanwhile selectively displays the image in each of the input/output modes.

4. The display device with an automatically rotated image according to claim 3, wherein the plurality of input/output modes at least comprises a computer input/output mode and a television input/output mode.

5. The display device with an automatically rotated image according to claim 4, wherein the television input/output mode comprises displaying an electronic program guide (EPG).

6. A display device with an automatically rotated image, wherein the display device outputs an image and a sound, and when the display device is rotated, the display device automatically switches the displaying direction of the image and maintains a sound output balance, comprising:
a magnetic sensor, for sensing a change in magnetic flux when the display device is rotated, and generating a first message comprising a first magnetic flux according to the change in magnetic flux;
a memory unit, for storing a second message comprising a second magnetic flux;
a MCU, electrically connected to the magnetic sensor, for determining whether to rotate the image or not, and the displaying direction of the image after being rotated according to the first and second messages;
a control unit, electrically connected to the MCU, for controlling the displaying direction of the image and maintaining a sound output balance together with the MCU;
a display unit, electrically connected to the control unit for outputting the image; and
a loudspeaker unit electrically connected to the control unit, comprising a plurality of loudspeakers and a plurality of sound channels, and each of the loudspeakers outputting the sound via each of the sound channels.

7. The display device with an automatically rotated image according to claim 6, wherein the MCU is responsible for proportionally allocating the length and width of the image and adjusting the displaying position of the image.

8. The display device with an automatically rotated image according to claim 6, wherein the display device has a plurality of input/output modes, and the MCU processes the image in each of the input/output modes according to each of the input/output modes, and meanwhile selectively displays the image in each of the input/output modes.

9. The display device with an automatically rotated image according to claim 8, wherein the plurality of input/output modes at least comprises a computer input/output mode and a television input/output mode.

10. The display device with an automatically rotated image according to claim 9, wherein the television input/output mode comprises displaying an EPG.

11. The display device with an automatically rotated image according to claim 6, wherein each of the plurality of loudspeakers and each of the plurality of sound channels are disposed one for one, and each of the loudspeakers is spaced with an equal distance there-between.

12. The display device with an automatically rotated image according to claim 11, wherein when the image is rotated, the plurality of loudspeakers and the plurality of sound channels are switched by a logic gate, so as to be disposed one for one.

13. A method for displaying an automatically rotated image applicable in a display device, wherein the display device comprises a magnetic sensor, a microprocessor control unit (MCU), a memory unit, a control unit, a display unit, and a loudspeaker unit, and when the display device is rotated, the display device automatically switches the displaying direction of an image, and maintains a sound output balance, the method comprising:
sensing a magnetic flux resulting from the rotation of the display device, and generating a first message comprising a first magnetic flux according to the magnetic flux;
retrieving a second message comprising a second magnetic flux from the memory unit; and
executing a predetermined program according to the first and second messages, so as to determine whether to rotate the image or not and determine the displaying direction after the image is rotated and the sound output balance.

14. The method for displaying an automatically rotated image according to claim 13, wherein the loudspeaker unit comprises a plurality of loudspeakers spaced with an equal distance there-between and a plurality of sound channels, the method further comprising:
disposing each of the loudspeakers and each of the sound channels one for one, wherein each of the loudspeakers outputs the sounds through each of the sound channels; and
rotating the image, switching the matching of each of the loudspeakers and each of the sound channels, so as to maintain the sound output balance in each of the sound channels.

15. The method for displaying an automatically rotated image according to claim 13, wherein the predetermined program comprises:
comparing the first magnetic flux with the second magnetic flux; and
if the first magnetic flux is larger than the second magnetic flux, the MCU determining that the image is rotated, and generating a third message and outputting it to the control unit, wherein the third message comprises an image direction message and a sound channel direction message.

16. The method for displaying an automatically rotated image according to claim 15, wherein the control unit generates a fourth message according to the third message and outputs the fourth message to the display unit, and the fourth message comprises an image control message for switching the displaying direction of the image.

17. The method for displaying an automatically rotated image according to claim 16, wherein the control unit generates a fifth message according to the third message, and outputs the fifth message to the loudspeaker unit, and the fifth message comprises a sound channel control message to maintain the sound output balance.
